(19) United States
(12) Patent Application Publication
(10) Pub. No.: US 2013/0167552 A1
(43) Pub. Date: Jul. 4, 2013

(54) EXHAUST STRUT AND TURBOMACHINE INCORPRATING SAME

(71) Applicants: Mayur Abhay Keny, Bangalore (IN); Thangaraj Subbareddyar, Bangalore (IN); Hariharan Sundaram, Bangalore (IN)

(72) Inventors: Mayur Abhay Keny, Bangalore (IN); Thangaraj Subbareddyar, Bangalore (IN); Hariharan Sundaram, Bangalore (IN)

(73) Assignee: GENERAL ELECTRIC COMPANY, Schenectady, NY (US)

(21) Appl. No.: 13/343,115

(22) Filed: Jan. 4, 2012

(51) Int. Cl. F02C 7/20

(52) U.S. Cl. 60/796

(57) ABSTRACT

An exhaust strut is provided and includes a body having an airfoil-shaped cross-section defining a lead edge portion and a trailing edge portion opposite the lead edge portion, the lead edge portion and the trailing edge portion being connected by a pressure side and a suction side opposite the pressure side, at least the lead edge portion and respective sections of the pressure side and the suction side proximate to the lead edge portion being formed of shape memory alloy, and a temperature control system operably disposed at the lead edge portion and the respective sections of the pressure side and the suction side proximate to the lead edge portion to modify a temperature of the shape memory alloy.

### BACKGROUND OF THE INVENTION

The subject matter disclosed herein relates to an exhaust strut and, more particularly, to an exhaust strut for use during at least off design conditions in turbomachinery, such as a power generation turbine.

Generally, a turbomachine, such as a power generation gas turbine engine, includes a turbine section and a diffusion section. The turbine section is configured to generate power and/or electricity from a flow of high temperature fluids and outputs turbine exhaust from a remainder of the high temperature fluids at an aft end thereof. The diffusion section is disposed downstream from the aft end of the turbine section and is fluidly coupled to the turbine section such that the turbine exhaust flows into the diffusion section. Within the diffusion section, the flow of the turbine exhaust is diffused and conditioned for exhaust into the atmosphere.

With increasing demand for flexible turbomachine operation, part load operations become important. At part load, flows from turbine section aft stages entering the diffusion section as exhaust may not be present as shock-less flows and may cause pressure losses. These pressure losses can directly impact turbomachine efficiency and usability at part load.

### BRIEF DESCRIPTION OF THE INVENTION

According to one aspect of the invention, an exhaust strut is provided and includes a body having an airfoil-shaped cross-section defining a lead edge portion and a trailing edge portion opposite the lead edge portion, the lead edge portion and the trailing edge portion being connected by a pressure side and a suction side opposite the pressure side, at least the lead edge portion and respective sections of the pressure side and the suction side proximate to the lead edge portion being formed of shape memory alloy, and a temperature control system operably disposed at the lead edge portion and the respective sections of the pressure side and the suction side proximate to the lead edge portion to modify a temperature of the shape memory alloy.

According to another aspect of the invention, an exhaust strut is provided and includes a body having an airfoil-shaped cross-section defining a lead edge portion and a trailing edge portion opposite the lead edge portion, the lead edge portion and the trailing edge portion being connected by a pressure side and a suction side opposite the pressure side, an external surface of the body being formed of shape memory alloy in strips along the lead edge portion, the trailing edge portion, the pressure side and the suction side, and a temperature control system operably disposed at the external surface of the body to modify a temperature of one or more of the strips of the shape memory alloy.

According to yet another aspect of the invention, a turbomachine is provided and includes a turbine section, a diffusion section disposed downstream from and is fluidly coupled to the turbine section and an exhaust strut disposed in a forward end of the diffusion section. The exhaust strut includes a body having an airfoil-shaped cross-section defining relative to a main flow proceeding through the turbine section and the diffusion section a lead edge portion and a trailing edge portion, the lead edge portion and the trailing edge portion being connected by a pressure side and a suction side, at least the lead edge portion and respective sections of the pressure side and the suction side proximate to the lead edge portion being formed of shape memory alloy and a temperature control system operably disposed at the lead edge portion and the respective sections of the pressure side and the suction side proximate to the lead edge portion to modify a temperature of shape memory alloy.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic side view of a turbomachine;

FIG. 2 is a perspective view of an exhaust strut of the turbomachine of FIG. 1;

FIG. 3 is a radial view of the exhaust strut of FIG. 2 in accordance with embodiments;

FIG. 4 is a radial view of the exhaust strut of FIG. 2 in accordance with embodiments; and

FIG. 5 is a radial view of the exhaust strut of FIG. 2 in accordance with embodiments.

The detailed description explains embodiments of the invention, together with advantages and features, by way of example with reference to the drawings.

### DETAILED DESCRIPTION OF THE INVENTION

In accordance with aspects, shape memory alloy (SMA) is provided to exhaust struts of a turbomachine, such as a gas turbine engine. In general, SMA has a characteristic property by which the SMA is able to remember an original shape thereof when a temperature thereof is changed above/below a characteristic transition temperature. As described herein, this property can be utilized to modify an orientation of an exhaust strut with respect to incoming flow from a turbine section. In particular, the SMA portion of the exhaust strut will be provided with a temperature control system through which secondary flow can be directed during at least part load operation. This secondary flow can be provided from a dedicated source or may be blower air that is otherwise used for cooling the exhaust strut. When the secondary flow is passed through the temperature control system, the SMA temperature may be modified to cause the SMA to shape-change. That is, the SMA can be made to shape-change in response to changes in flow temperatures or any measurable turbine parameter brought about by load changes to thereby permit shock-less entry of incoming flows from the turbine section.

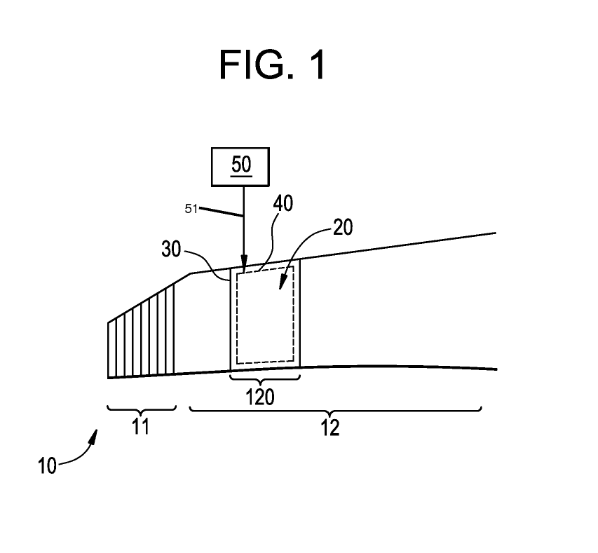

With reference to FIG. 1, a turbomachine 10, such as a power generation gas turbine engine, is provided. The turbomachine 10 includes a turbine section 11 and a diffusion section 12. The turbine section 11 is configured to generate power and/or electricity from a flow of high temperature fluids and outputs a remainder of the high temperature fluids as turbine exhaust from aft axial stages at an aft end thereof The diffusion section 12 is disposed downstream from the aft end of the turbine section 11 and is fluidly coupled to the turbine section 11 such that the turbine exhaust flows into the diffusion section 12. Within the diffusion section 12, the flow of the turbine exhaust is diffused and conditioned for exhaust into the atmosphere.

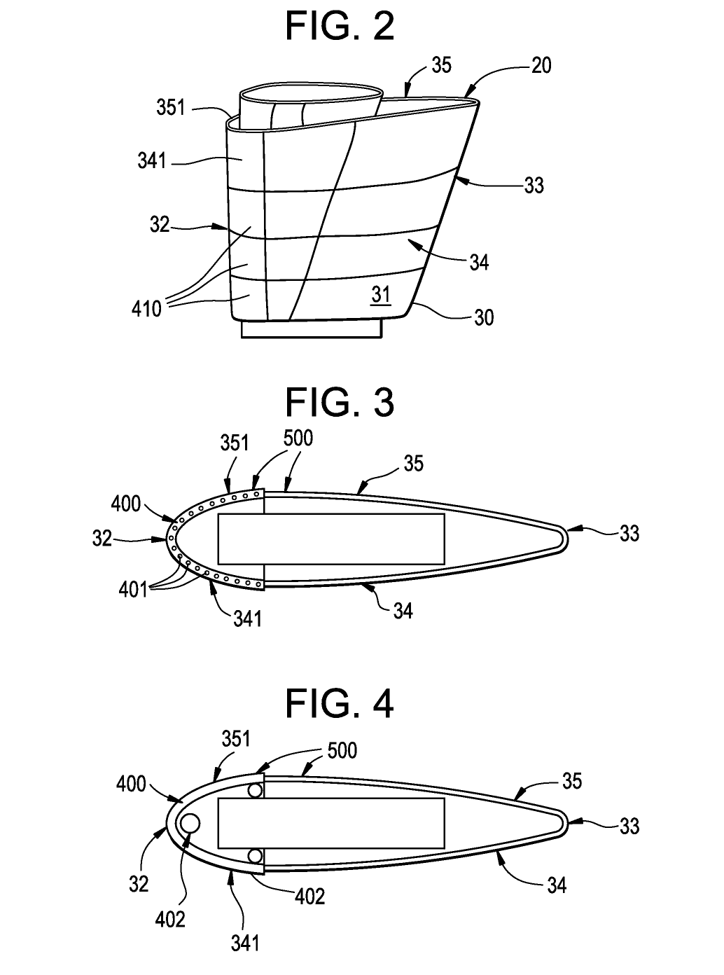

With reference to FIGS. 1 and 2, the turbomachine 10 further includes one or more exhaust struts 20, which are each disposed in a forward end 120 of the diffusion section 12. Each exhaust strut 20 includes a body 30 and a temperature control system 40. The body 30 has an airfoil-shaped cross-section 31, which defines a lead edge portion 32, a trailing edge portion 33 a pressure side 34 and a suction side 35 relative to a main flow of the turbine exhaust proceeding from the turbine section 11 and into the diffusion section 12. As shown in FIG. 2, the trailing edge portion 33 is opposite the lead edge portion 32 and the pressure side 34 is opposite the suction side 35.

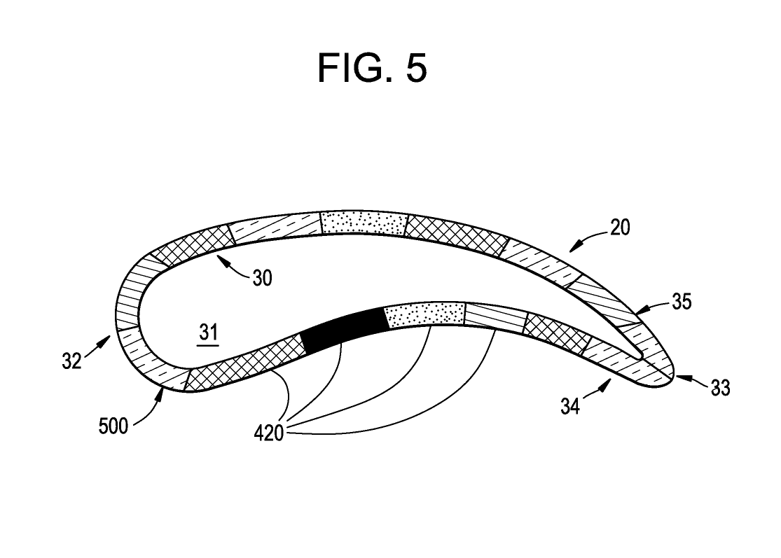

The pressure side 34 extends between the lead edge portion 32 and the trailing edge portion 33 to define a section 341 of the pressure side that is proximate to the lead edge portion 32. Similarly, the suction side 35 extends between the lead edge portion 32 and the trailing edge portion 33 to define a section 351 of the suction side that is proximate to the lead edge portion 32. In accordance with embodiments, the body 30 may be formed of SMA 400 (see FIG. 5) and, in accordance with further embodiments, at least the lead edge portion 32 and the respective sections 341, 351 of the pressure side 34 and the suction side 35 that are each defined proximate to the lead edge portion 32 are formed of SMA 400 (see FIGS. 3 and 4).

With reference to FIGS. 3 and 4, the turbomachine 10 further includes the temperature control system 40 mentioned above, which may be disposed about the body 30 to be positioned to modify the temperature of parts of or the entire body 30. In particular, the temperature control system 40 may be disposed at or near the lead edge portion 32 and the respective sections 341, 351 of the pressure side 34 and the suction side 35. With this arrangement, the temperature control system 40 may be configured to modify the temperature of SMA 400 such that the exhaust strut 20 can shape-change in accordance with at least the incidence of part load conditions.

In accordance with embodiments, as shown in FIG. 3, the temperature control system 40 may include holes 401 formed in the SMA 400. The holes 401 may be oriented to extend along a dimension of a span of the exhaust strut 20 and may extend along the entire length of the exhaust strut 20 or, in some or all cases, along a partial length of the exhaust strut 20. In accordance with alternate embodiments, as shown in FIG. 4, the temperature control system 40 may include fluid pipes 402. The fluid pipes 402 may be disposed proximate to the SMA 400 and may be oriented to extend along the dimension of the span of the exhaust strut 20 and may extend along the entire length of the exhaust strut 20 or, in some or all cases, along a partial length of the exhaust strut 20. In any case, the cooling holes 401 or the fluid pipes 402 may be provided in the SMA 400 in one or more of a radial, axial and serpentine scheme or any other similar type of scheme.

The temperature control system 40 is thus configured to direct a secondary flow toward at least the SMA 400 during at least part load operation of the turbomachine 10. This secondary flow can be provided from a dedicated source or may be blower air that is otherwise used for cooling the exhaust strut 20. Piping 51 (see FIG. 1) may be disposed to transport the secondary flow from the dedicated source or the source of the blower air to the exhaust strut 20.

With reference back to FIG. 2 and with reference to FIG. 5, the SMA 400 may be provided in radial strips 410, which are respectively arranged along the span of the body 30 of the exhaust strut 20, or in axial/chordal strips 420, which are respectively arranged about an exterior surface of the body 30. In either or both cases, the various radial strips 410 and the various axial/chordal strips 420 can be actuated by the temperature control system 40 as a single unit or independently of one another. In the latter case, the independent temperature control of the various radial strips 410 and the various axial/chordal strips 420 can be controlled in accordance with a temperature profile of the exhaust strut 20 or an incoming flow profile during or at least the part load conditions. Although described herein as radial or axial/chordal, it is noted that these configurations are merely exemplary and that the strips can be provided in any orientation deemed appropriate.

With reference back to FIG. 1, the temperature control system 40 of the turbomachine 10 may further include a processing unit 50. The processing unit 50 may be provided with an integrated or separate storage unit on which executable instructions are stored. When executed, the executable instructions cause the processing unit 50 to control the temperature control system 40 to modify the temperature of SMA 400 in accordance with at least a predefined algorithm for at least the part load conditions. In an exemplary embodiment, the processing unit 50 may control the temperature control system 40 to modify the temperature of the various radial strips 410 and/or the various axial/chordal strips 420 separately or in combination with one another.

In accordance with embodiments, the processing unit 50 may be configured to receive as inputs and thereby sense at least one of a load and/or an operational change of the turbomachine 10. The processing unit 50 could thus control the temperature of the SMA 400 accordingly. Also, to the extent that the SMA 400 may not sufficiently cause a shape-change, it is to be understood that an auxiliary mechanical device may be provided to mechanically change a shape of the exhaust strut 20.

In accordance with still further embodiments and, with reference to FIGS. 2-5, the body 30 may be covered by a thermal barrier coating (TBC) 500 (see FIGS. 3-5). This TBC 500 may be provided to maintain a given temperature of the body 30 and to protect at least the SMA 400 from exposure to high temperatures and pressures associated with a turbine environment.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An exhaust strut, comprising:
a body having an airfoil-shaped cross-section defining a lead edge portion and a trailing edge portion opposite the lead edge portion, the lead edge portion and the trailing edge portion being connected by a pressure side and a suction side opposite the pressure side,
at least the lead edge portion and respective sections of the pressure side and the suction side proximate to the lead edge portion being formed of shape memory alloy; and
a temperature control system operably disposed at the lead edge portion and the respective sections of the pressure side and the suction side proximate to the lead edge portion to modify a temperature of the shape memory alloy.

2. The exhaust strut according to claim 1, wherein the temperature control system comprises holes formed in the shape memory alloy.

3. The exhaust strut according to claim 1, wherein the temperature control system comprises fluid pipes disposed proximate to the shape memory alloy.

4. The exhaust strut according to claim 1, wherein the temperature control system is formed in one or more of a radial, axial and serpentine scheme.

5. The exhaust strut according to claim 1, wherein the shape memory alloy is provided in strips along a span of the body.

6. The exhaust strut according to claim 1, wherein the trailing edge portion and additional sections of the pressure side and the suction side are formed of shape memory alloy.

7. The exhaust strut according to claim 5, wherein the shape memory alloy is provided in strips along the lead edge portion, the trailing edge portion, the pressure side and the suction side.

8. The exhaust strut according to claim 1, wherein the temperature control system comprises a processing unit, which is configured to control temperature of the shape memory alloy in accordance with at least a predefined algorithm.

9. The exhaust strut according to claim 8, wherein the processing unit is configured to sense at least one of a load or operational change and to control the temperature of the shape memory alloy accordingly.

10. The exhaust strut according to claim 1, further comprising a thermal barrier coating to cover the body.

11. An exhaust strut, comprising:
a body having an airfoil-shaped cross-section defining a lead edge portion and a trailing edge portion opposite the lead edge portion, the lead edge portion and the trailing edge portion being connected by a pressure side and a suction side opposite the pressure side,
an external surface of the body being formed of shape memory alloy in strips along the lead edge portion, the trailing edge portion, the pressure side and the suction side; and
a temperature control system operably disposed at the external surface of the body to modify a temperature of one or more of the strips of the shape memory alloy.

12. The exhaust strut according to claim 11, wherein the temperature control system comprises holes formed in the strips of the shape memory alloy.

13. The exhaust strut according to claim 11, wherein the temperature control system comprises fluid pipes disposed proximate to the strips of the shape memory alloy.

14. The exhaust strut according to claim 11, wherein the temperature control system comprises a processing unit, which is configured to control temperature of one or more of the strips of the shape memory alloy in accordance with at least a predefined algorithm.

15. A turbomachine, comprising:
a turbine section;
a diffusion section disposed downstream from and is fluidly coupled to the turbine section; and
an exhaust strut disposed in a forward end of the diffusion section and including:
a body having an airfoil-shaped cross-section defining relative to a main flow proceeding through the turbine section and the diffusion section a lead edge portion and a trailing edge portion, the lead edge portion and the trailing edge portion being connected by a pressure side and a suction side, at least the lead edge portion and respective sections of the pressure side and the suction side proximate to the lead edge portion being formed of shape memory alloy; and
a temperature control system operably disposed at the lead edge portion and the respective sections of the pressure side and the suction side proximate to the lead edge portion to modify a temperature of the shape memory alloy.

16. The turbomachine according to claim 15, wherein the temperature control system comprises holes formed in the shape memory alloy and fluid pipes disposed proximate to the shape memory alloy.

17. The turbomachine according to claim 15, wherein the shape memory alloy is provided in strips along a span of the body.

18. The turbomachine according to claim 15, wherein the trailing edge portion and additional sections of the pressure side and the suction side are formed of shape memory alloy.

19. The turbomachine according to claim 18, wherein the shape memory alloy is provided in strips along the lead edge portion, the trailing edge portion, the pressure side and the suction side.

20. The turbomachine according to claim 15, wherein the temperature control system comprises a processing unit, which is configured to control the temperature of the shape memory alloy in accordance with at least a predefined algorithm.
